(19) United States
(12) Patent Application Publication
(10) Pub. No.: US 2025/0037009 A1
(43) Pub. Date: Jan. 30, 2025

(54) METHOD, ELECTRONIC DEVICE, AND PROGRAM PRODUCT FOR GENERATING MACHINE LEARNING MODEL

(71) Applicant: Dell Products L.P., Round Rock, TX (US)

(72) Inventors: Zijia Wang, Weifang (CN); Zhisong Liu, Shenzhen (CN); Qiang Chen, Shanghai (CN); Zhen Jia, Shanghai (CN)

(21) Appl. No.: 18/240,824

(22) Filed: Aug. 31, 2023

(30) Foreign Application Priority Data
Jul. 27, 2023 (CN) 202310934993.9

(51) Int. Cl. G06N 20/00

(52) U.S. Cl. CPC G06N 20/00

(57) ABSTRACT

Embodiments of the present disclosure relate to a method for generating a machine learning model. The method includes extracting multiple parameters from a target machine learning model, where the multiple parameters include a learning rate, state information, a loss value, a gradient, and a weight, and the target machine learning model is configured to execute tasks related to at least one of images, videos, voice, and text. The method further includes predicting a first learning rate by a first machine learning model based on the multiple parameters; predicting a second learning rate by a second machine learning model based on the multiple parameters; choosing, based on the first learning rate and the second learning rate, a learning rate having a minimum loss value in the first learning rate and the second learning rate; and adjusting the target machine learning model based on the learning rate having the minimum loss value.

### RELATED APPLICATION

The present application claims priority to Chinese Patent Application No. 202310934993.9, filed Jul. 27, 2023, and entitled “Method, Electronic Device, and Program Product for Generating Machine Learning Model,” which is incorporated by reference herein in its entirety.

### FIELD

Embodiments of the present disclosure relate to a method, an electronic device, and a computer program product for generating a machine learning model.

### BACKGROUND

In a machine learning model, hyperparameters such as a learning rate, the number of iterations, an initialization weight, and the size and number of convolutional kernels play a crucial role in determining the performance of the machine learning model.

In these hyperparameters, the learning rate can affect a step size of updating parameters during a training process of the machine learning model, thereby affecting a training speed, quality, and generalization ability of the machine learning model. However, methods commonly used to set the learning rate rely on heuristic or simple search methods, resulting in unsatisfactory results.

### SUMMARY

Embodiments of the present disclosure relate to a method, an electronic device, and a computer program product for generating a machine learning model.

According to a first aspect of the present disclosure, a method for machine model training is provided. The method includes extracting multiple parameters from a target machine learning model, where the multiple parameters include a learning rate, state information, a loss value, a gradient, and a weight, and the target machine learning model is configured to execute tasks related to at least one of images, videos, voice, and text. The method further includes predicting, by a first machine learning model based on the multiple parameters, a first learning rate associated with the target machine learning model; predicting, by a second machine learning model based on the multiple parameters, a second learning rate associated with the target machine learning model; choosing, based on the first learning rate and the second learning rate, a learning rate having a minimum loss value in the first learning rate and the second learning rate; and adjusting the target machine learning model based on the learning rate having the minimum loss value.

According to a second aspect of the present disclosure, an electronic device for generating a machine learning model is provided. The electronic device includes at least one processor; and a memory coupled to the at least one processor and having instructions stored thereon, where the instructions, when executed by the at least one processor, cause the electronic device to perform actions including: extracting multiple parameters from a target machine learning model, where the multiple parameters include a learning rate, state information, a loss value, a gradient, and a weight, and the target machine learning model is configured to execute tasks related to at least one of images, videos, voice, and text. The actions further include predicting, by a first machine learning model based on the multiple parameters, a first learning rate associated with the target machine learning model; predicting, by a second machine learning model based on the multiple parameters, a second learning rate associated with the target machine learning model; choosing, based on the first learning rate and the second learning rate, a learning rate having a minimum loss value in the first learning rate and the second learning rate; and adjusting the target machine learning model based on the learning rate having the minimum loss value.

According to a third aspect of the present disclosure, a computer program product is provided. The computer program product is tangibly stored on a non-transitory computer-readable medium and comprises machine-executable instructions, wherein the machine-executable instructions, when executed by a machine, cause the machine to perform steps of the method in the first aspect of the present disclosure.

### BRIEF DESCRIPTION OF THE DRAWINGS

By description of example embodiments of the present disclosure, provided in more detail herein with reference to the accompanying drawings, the above and other objectives, features, and advantages of the present disclosure will become more apparent. In the example embodiments of the present disclosure, the same reference numerals generally represent the same elements.

FIG. 1 shows a schematic diagram of an example system in which a device and/or a method of embodiments of the present disclosure can be implemented;

FIG. 2 shows a flow chart of a method for generating a machine learning model according to embodiments of the present disclosure;

FIG. 3 shows a schematic diagram of a process for training a reinforcement learning model according to embodiments of the present disclosure; and

FIG. 4 shows a block diagram of an example device that can be used to implement embodiments of the present disclosure.

### DETAILED DESCRIPTION

Illustrative embodiments of the present disclosure will be described in more detail below with reference to the accompanying drawings. While some specific embodiments of the present disclosure are shown in the accompanying drawings, it should be understood that the present disclosure may be implemented in various forms, and should not be viewed as being limited to the embodiments set forth herein. Rather, these embodiments are provided to make the present disclosure more thorough and complete and to fully convey the scope of the present disclosure to those skilled in the art.

The term “include” and variants thereof used in this text indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

The methods commonly used to train an optimal learning rate for a machine model include using grid search or random search. However, these methods are usually computationally expensive, and the ability to find the best hyperparameter for the best learning rate may be limited. Another method is to use a dynamic learning rate plan, such as stepped attenuation or exponential attenuation, which adjusts the learning rate according to a predefined plan. Although these methods can provide improved performance compared with fixed learning rates, they are still limited by schedule selection. In known methods, it is difficult to determine optimized values for hyperparameters such as the learning rate from previously provided data, which is also costly and time-consuming, conventional methods of adjusting hyperparameters are usually implicit and not intelligent, resulting in poor performance, while the selection of hyperparameters can greatly affect the convergence speed and overall performance of machine models. In addition, these methods can also use other features or statistical data, such as channel quality or collision probability, and are designed for specific fields (such as wireless communication or robot technologies).

To at least solve the above and other potential problems, embodiments of the present disclosure provide a method for generating a machine learning model. The method includes extracting multiple parameters from a target machine learning model, where the multiple parameters include a learning rate, state information, a loss value, a gradient, and a weight, and the target machine learning model is configured to execute tasks related to at least one of images, videos, voice, and text. The method further includes predicting, by a first machine learning model based on the multiple parameters, a first learning rate associated with the target machine learning model; predicting, by a second machine learning model based on the multiple parameters, a second learning rate associated with the target machine learning model; choosing, based on the first learning rate and the second learning rate, a learning rate having a minimum loss value in the first learning rate and the second learning rate; and adjusting the target machine learning model based on the learning rate having the minimum loss value. By means of the method, a combination of multiple different methods (including but not limited to a reinforcement learning model, a neural network model, and/or any other machine learning model) to adjust the learning rate can be implemented, so as to form a more intelligent and more efficient solution; a future value of the learning rate during the training process is predicted so as to perform real-time adjustment and improve convergence and provide a faster convergence speed and better performance of the machine learning model.

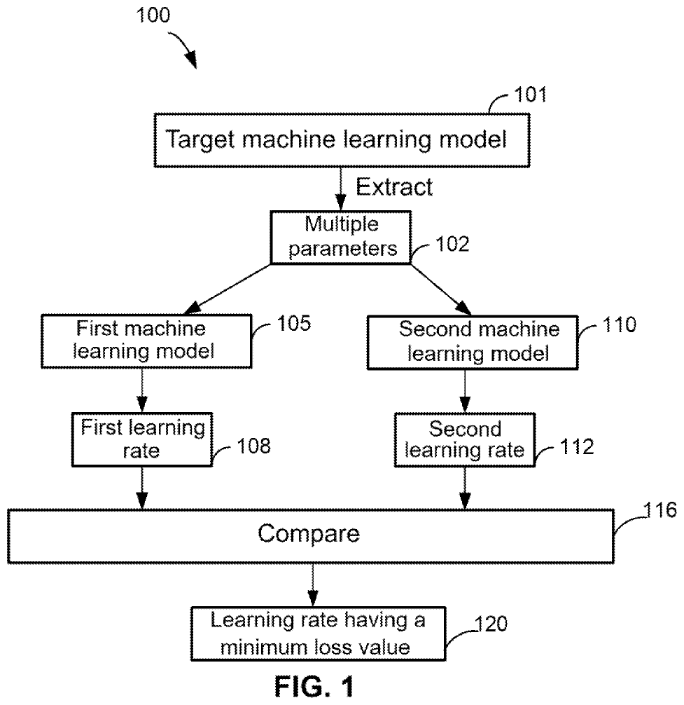

Fundamental principles and a plurality of example embodiments of the present disclosure will be described in detail below with reference to the accompanying drawings. FIG. 1 shows a schematic diagram of an example system 100 in which a device and/or a method of embodiments of the present disclosure can be implemented. FIG. 1 may include a target machine learning model 101, a first machine learning model 105, and a second machine learning model 110. It should be understood that the categories and quantity of models, data transmission processes, arrangements, and the like shown in FIG. 1 are merely illustrative, and the example system 100 may include different quantities of models arranged in different manners, data transmission processes, various additional elements, and so on. It should be understood that the above example is merely used for illustrating an application of the target machine learning model 101. With the development of technologies, the target machine learning model 101 may include various applications in various fields and aspects.

In the example system 100, the target machine learning model 101, the first machine learning model 105, and the second machine learning model 110 can be installed in any computing device that has processing computing resources or storage resources. For example, the computing device may have common capabilities such as receiving and sending data requests, real-time data analysis, local data storage, and real-time network connectivity. The computing device may typically include various types of devices. Examples of the computing device may include, but are not limited to, desktop computers, laptops, smartphones, wearable devices, security devices, intelligent manufacturing devices, smart home devices, Internet of things (IoT) devices, smart cars, drones, and so on, which are not limited in the present disclosure.

According to embodiments of the present disclosure, a loss function for the target machine learning model 101 can be represented as L(w), where w represents a model parameter. The learning rate of the target machine learning model 101 can be represented as a, which represents an updating amplitude of parameters of the target machine learning model 101 in each iteration. The target can be to find an optimal learning rate α*, so as to improve convergence of the target machine learning model 101 for the optimal parameter w*. The process may be represented as:

$${α}^{*} = arg {min}_{α} L ( w ( α ) ) \qquad ( 1 )$$

where w(α) is a model parameter with a learning rate α at an iteration t. According to embodiments of the present disclosure, multiple different modes, including but not limited to a reinforcement learning model and a machine learning model, can be used to predict and adjust the learning rate in the training process so as to achieve an optimal α*.

According to embodiments of the present disclosure, the first machine learning model 105 can be a reinforcement learning model. The training process of the reinforcement learning model can provide a frame for optimizing decision-making in a dynamic environment. The reinforcement learning model focuses on how an agent takes actions in a dynamic environment to obtain maximum accumulated rewards.

The training process of the reinforcement learning model can include multiple elements such as agents, environments, states, actions, rewards, etc. Among them, the agent is responsible for taking actions in the environment, and the agent can be a robot or other entities that need to learn how to make decisions. The environment can be real or virtual, and can provide feedback on the actions of the agent, including rewards and state transitions; the state represents a specific state of the environment at a certain moment, which can be used to describe information about the environment. At each time step, the agent observes the current state and makes decisions based on the state. The reward function for rewards can be the feedback provided by the environment to the agent at each time step, representing an evaluation of the agent's actions. The reward can be positive (encouraging the agent to continue taking similar actions) or negative (punishing the agent to avoid similar actions). The goal of the reinforcement learning model is to learn an optimal strategy through the interaction with the environment, such that the agent can choose the optimal action through continuous trial and error, in order to maximize accumulated rewards. The process of the reinforcement learning model is usually an iterative process, where the agent constantly tries and improves its own strategy during the training process to achieve better results.

In the context of machine learning, a learning rate can be considered as a decision made during each iteration according to a current state of a model and information of previous iterations. The reinforcement learning model can be trained to make this decision, and the goal is to minimize the loss function. Additionally or alternatively, the first machine learning model 105 can also be based on other types of machine learning models, which is not limited in the present disclosure. According to embodiments of the present disclosure, the current state and the loss value of the target machine learning model 101 can be used to train the first machine learning model 105, so as to predict an optimal learning rate for the target machine learning model 101 at a given iteration during the training process. According to some embodiments of the present disclosure, state data of the model at iteration t during a generation process of the target machine learning model 101 can be represented by a vector Sₜ, and the loss value at iteration t can be represented by Lₜ. The training goal of the first machine learning model 105 is to predict an optimal learning rate αₜ of the target machine learning model 101 at the next iteration t+1.

During the training process, the action space of the first machine learning model 105 can be a set of all possible learning rates at given iterations during the training process. The state space can be a representation of a current state of the model, including information such as a current weight, a gradient, and a loss value. The reward space/reward function is a set of all possible loss values that can be generated by the first machine learning model 105, and the goal is to minimize the value. A reward signal can be defined as a difference value between the current loss and the target loss, and used as an indicator of the quality of the chosen learning rate.

The reinforcement learning model can be represented as a Markov Decision Process (MDP), where the state sₜ, the action αₜ, and the reward Lₜ can form a tuple (sₜ, αₜ, Lₜ). The action αₜ is a first learning rate chosen by the first machine learning model 105, and the reward Lₜ is the loss value. The goal of the first machine learning model 105 is to find a strategy network/optimal strategy π*, and maximize the predicted reward along with the time at a given current state sₜ:

$${π}^{*} ( {s}_{t} ) = {arg max}_{{α}_{t}} {𝔼}_{{s}_{t + 1}} ∼ p [ {r}_{t + 1} + γ {\sum }_{k = 0}^{∞} {γ}^{k} {r}_{t + k + 1} \vert {s}_{t} , {α}_{t} ] \qquad ( 2 )$$

where π*(sₜ) represents an optimal strategy, at is an action adopted at the time step t, [symbol] ₛ_{ₜ₊₁}˜p represents the expectation of distribution of a next state sₜ₊₁ of the given current state sₜ and action αₜ, rₜ₊₁ is an instant reward at the time step t+1, γ is a discount factor, and the sum represents a cumulative discount reward within an infinite horizon.

It should be understood that various methods can be used to train the first machine learning model 105, including but not limited to Q learning, a strategy gradient method, and so on. During training, the first machine learning model 105 can be updated based on estimated values of observed rewards and future rewards.

Once the first machine learning model 105 is trained, it can be used to predict an optimal learning rate αₜ of each iteration t during the training process. The first machine learning model 105 can use the current state sₜ and the current loss Lₜ of the target machine learning model 101 as inputs and output a predicted first learning rate αₜ. The target machine learning model 101 can then use the predicted learning rate to update a weight of the model in the next iteration.

Additionally or alternatively, in some embodiments, multiple learning rates predicted by the first machine learning model 105 can be compared with a previously marked target benchmark truth learning rate, so as to choose therefrom a predicted learning rate closest to the target benchmark truth learning rate for the target machine learning model 101. In other words, the predicted learning rate and the target benchmark truth learning rate can have a minimum loss value. The target benchmark truth learning rate for the target machine learning model 101 can be confirmed by means of a previous manual or automatic grid search method. For example, multiple parameters 102 of the target machine learning model 101 can be first extracted, and a learning rate for the target machine learning model 101 can be from 0.5 to 0.05. One or more target benchmark truth learning rates suitable for the target machine learning model 101 are obtained during a debugging process by progressively decreasing the learning rate, for example, progressively decreasing 0.01 each time, and debugging parameters during the decreasing process.

According to embodiments of the present disclosure, the second machine learning model 110 can be further trained, so as to cause the second machine learning model 110 to predict a second learning rate associated with the target machine learning model 101. As an example, in the present disclosure, the second machine learning model 110 can be a neural network machine learning model, which can simulate the method of processing information in the human brain, so as to learn and perform tasks such as classification, regression, and image processing. The neural network machine learning model can be composed of multiple layers, each containing multiple neurons or nodes. These layers are connected by weights, and the patterns and features of the data are learned during the training process by adjusting the weights. As an example, the neural network machine learning model can include but is not limited to a feedforward neural network layer, which is used to transfer information from an input layer to an output layer via a hidden layer; a convolutional neural network layer, which is configured to extract or pool, for example, features in image data; a generator and a discriminator for adversarial training of data; and components such as transformers for implementing attention mechanisms, which are not limited in the present disclosure.

It should be understood that the above description of the second machine learning model 110 is merely illustrative. The second machine learning model 110 can be any machine learning model, including but not limited to decision trees, random forests, support vector machines (SVM), logistic regression models, K-means clustering, hierarchical clustering, principal component analysis (PCA), autoencoders, reinforcement learning models, transfer learning models, generative adversarial network models, sequence models, recurrent neural network (RNN) models, long-short term memory network (LSTM) models, transformers, gradient boosting decision trees, ensemble learning models, etc., which is not limited in the present disclosure.

Similarly, multiple parameters 102 of the target machine learning model 101 can first be obtained as an input feature, including but not limited to its current weight, loss value, and a target value for a next iteration. These obtained multiple parameters 102 can be used as training data and fed to the second machine learning model 110 for training the second machine learning model 110. In a case where the current weight and loss of a main model are given, the second machine learning model 110 can predict an optimal learning rate of the next iteration. The above training process can be represented by the following loss function:

$$L = {\sum }_{i = 1}^{n} {( {α}_{true , i} - {α}_{pred , i} )}^{2} \qquad ( 3 )$$

where n is the quantity of samples in the training data, α_{true,i} is a target benchmark truth learning rate for the ith sample, and α_{pred,i} is a learning rate predicted by the second machine learning model 110.

The second machine learning model 110 is continuously adjusted and trained by minimizing the difference between the learning rate α_{pred,i} predicted by the second machine learning model 110 and the target benchmark truth learning rate α_{true,i} (i.e., there is a minimum loss function value between the two). For example, the second machine learning model 110 can be continuously adjusted and optimized by adjusting the content of the sample data and the quantity of the sample data for training of the second machine learning model 110.

After the training process of the second machine learning model 110 is completed, the second machine learning model 110 can be used to predict an optimal learning rate during the training process of the target machine learning model 101, and the process can be represented by the following formula:

$${α}_{pred} = f ( weight , loss ) \qquad ( 4 )$$

where f is the trained second machine learning model 110, and weight and loss are the current weight and loss value of the target machine learning model 101.

According to embodiments of the present disclosure, a reasoning phase can be further included. In this phase, the first machine learning model 105 and the second machine learning model 110 can be used to respectively predict the optimal learning rate for the target machine learning model 101. Specifically, one or more current values of the learning rate, the state information, the loss value, the gradient, and the weight in the current iteration of the target machine learning model 101 can be first obtained. Subsequently, the first machine learning model 105 can be used to predict and generate the first learning rate 108 based on the learning rate, the state information, the loss value, the gradient, and the weight for the target machine learning model 101.

Similarly, the second machine learning model 110 can be used to predict and generate the second learning rate 112 based on the learning rate, the state information, the loss value, the gradient, and the weight for the target machine learning model 101. Subsequently, the first learning rate 108 and the second learning rate 112 can be respectively compared 116 with the target benchmark truth learning rate, so as to choose, from the two, a learning rate 120 (having the minimum loss value or highest predicted reward) closest to the target benchmark truth learning rate. Then, the target machine learning model 101 can be adjusted based on the learning rate 120 having the minimum loss value.

Additionally or alternatively, after a learning rate predicted and generated by a model is chosen, adjustment and training of the other model can be continued. For example, after the first learning rate 108 predicted and generated by the first machine learning model 105 is chosen, adjustment and training of the second machine learning model 110 can be continued, and a new second learning rate 112 predicted and generated by the adjusted second machine learning model 110 can be used for comparison during a next iterative training process. The above process can be repeated and iterated until the training process is completed, such as achieving an expected learning rate or optimization effect expected by a user.

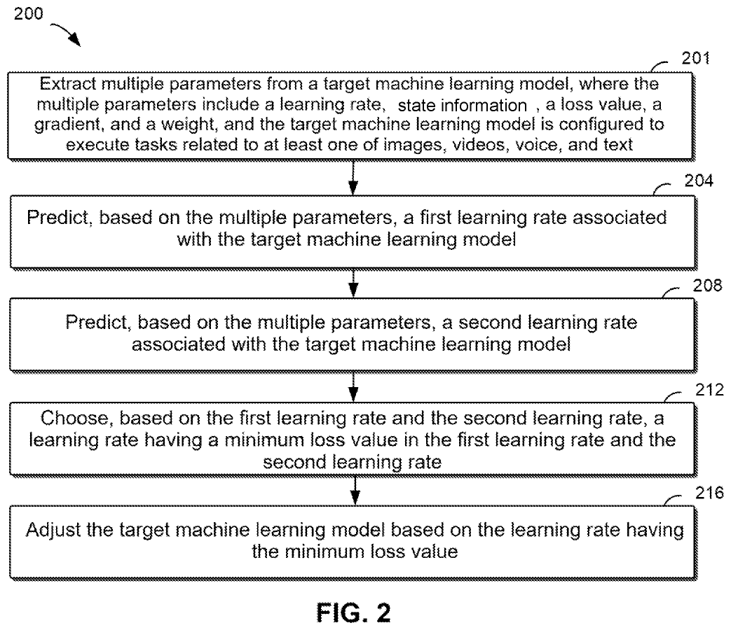

A schematic diagram of a system in which a method and/or a process according to embodiments of the present disclosure can be implemented is described above with reference to FIG. 1. A flow chart of a method 200 for generating a machine learning model according to embodiments of the present disclosure will be described below with reference to FIG. 2. The method 200 for generating a machine learning model according to embodiments of the present disclosure can be executed at an edge device with a computing capability or executed at a cloud-end server, which is not limited in the present disclosure. To generate a machine learning model and its related learning rate more efficiently, the method 200 for generating a machine learning model according to embodiments of the present disclosure is provided.

At a block 201, multiple parameters are extracted from a target machine learning model, where the multiple parameters include a learning rate, state information, a loss value, a gradient, and a weight, and the target machine learning model is configured to execute tasks related to at least one of images, videos, voice, and text. The target machine learning model can be a machine learning model used to execute one or more tasks of image processing, natural language (NLP) processing, data modeling, personalized recommendation, demand prediction, anomaly detection, video processing, voice processing, text processing, etc. The multiple parameters can be any parameter associated with the target machine learning model.

At a block 204, a first learning rate associated with the target machine learning model is predicted based on the multiple parameters. According to embodiments of the present disclosure, a reinforcement learning model as a first machine learning model can dynamically predict the first learning rate associated with the target machine learning model based on parameters such as the state information, the loss value, the gradient, and the weight in the multiple parameters previously extracted and according to the training progress and environment changes.

At a block 208, a second learning rate associated with the target machine learning model is predicted based on the multiple parameters. As an example, according to embodiments of the present disclosure, as a second machine learning model, a machine learning model such as a neural network model can similarly predict the second learning rate associated with the target machine learning model based on parameters such as the state information, the loss value, the gradient, and the weight in the multiple parameters previously extracted and additionally based on historical sample data accumulated in previous experiments.

At a block 212, the learning rate having a minimum loss value in the first learning rate and the second learning rate can be chosen based on the first learning rate and the second learning rate. The first learning rate and the second learning rate can be compared respectively with a target benchmark learning rate to choose the learning rate having a minimum difference from the target benchmark learning rate, with the target benchmark learning rate having been determined by using a grid search method. In practice, the target benchmark learning rate can usually be ultimately determined by conducting experiments, adjusting parameters, and attempting different learning rate strategies.

According to some embodiments of the present disclosure, if the first learning rate predicted by the first machine learning model is determined as the learning rate with the minimum loss value, the second machine learning model can be adjusted to minimize a difference between the second learning rate predicted by the second machine learning model and the target benchmark learning rate. Specifically, the difference between the second learning rate generated by the second machine learning model and the target benchmark learning rate can be reduced by adjusting sample data of the second machine learning model for predicting the second learning rate and the quantity of the sample data.

According to some embodiments of the present disclosure, if the second learning rate predicted by the second machine learning model is determined as the learning rate with the minimum loss value, the first machine learning model can be adjusted to minimize a difference between the first learning rate predicted by the first machine learning model and the target benchmark learning rate. Specifically, the difference between the first learning rate generated by the first machine learning model and the target benchmark learning rate can be reduced by adjusting the first machine learning model by means of one or more methods of a Q learning method and/or a strategy gradient method.

Additionally or alternatively, when the difference between the first learning rate generated by the first machine learning model and the target benchmark learning rate is reduced, a reward value (a difference value from the target benchmark learning rate) associated with the first learning rate is obtained, and the first machine learning model is adjusted based on the reward value. For example, the first machine learning model may be caused to be trained in the direction in which the difference between the first learning rate and the target benchmark learning rate is reduced and used to predict another learning rate of a next iteration. In each iteration of a process of multiple iteration training adjustments for the target machine learning model, one of the first machine learning model or the second machine learning model can be adjusted.

At a block 216, the target machine learning model can be adjusted finally based on the determined learning rate having the minimum loss value. For example, the target machine learning model can adjust, based on the determined learning rate, a step size of the corresponding training process for updating parameters, that is, the amplitude of updating parameters in the parameter space in a direction of gradient descent, so as to finally achieve a faster convergence speed and stability for training the target machine learning model, avoid over-fitting, and improve computational efficiency.

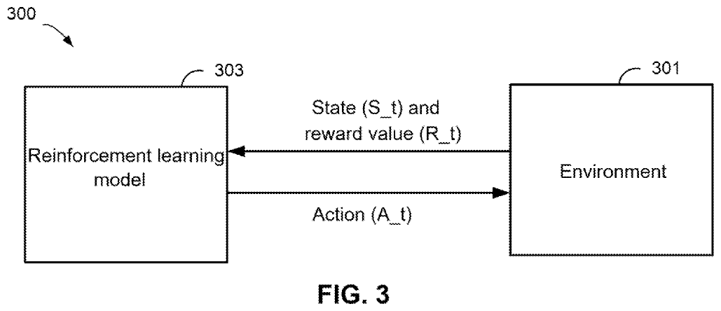

FIG. 3 shows a schematic diagram of a process 300 for training a reinforcement learning model according to embodiments of the present disclosure. As shown in FIG. 3, an environment 301 and a reinforcement learning model 303 can be included. The environment 301 is a scenario for which the reinforcement learning model 303 learns and makes decisions. As an example, in embodiments of the present disclosure, the environment 301 can be a process for generating a target machine learning model. At each time step t, the environment 301 receives an action (A_t) of the reinforcement learning model 303, returns a reward value (R_t) according to the current state and action, and transfers to a new state. The state (S_t) of the environment 301 represents a current observed value of the environment and is information describing the current situation of the environment. The reinforcement learning model 303 chooses an action according to the state (S_t). As an example, the state (S_t) in the present disclosure can be one or more parameters associated with the target machine learning model.

The reinforcement learning model 303 is the subject of learning and decision-making. It chooses the action (A_t) according to the current state by interacting with the environment 301, and learns and optimizes strategies according to the reward value returned by the environment. The action (A_t) may be an action executed by the reinforcement learning model 303 at each time step. The reinforcement learning model 303 chooses an action according to the current state, and transfers it to the environment 301. As an example, in embodiments of the present disclosure, the action (A_t) may be a learning rate predicted by the reinforcement learning model 303 for the target machine learning model.

The reward value (R_t) is a signal returned by the environment after the reinforcement learning model 303 executes the action for evaluating the quality of the action. The reward value (R_t) is a key feedback signal in reinforcement learning, and the goal of the reinforcement learning model 303 is to maximize the accumulated rewards by learning and adjusting the strategies. As an example, in embodiments of the present disclosure, the reward value (R_t) can be a difference between a learning rate predicted by the reinforcement learning model 303 and a benchmark truth learning rate. If the action executed by the reinforcement learning model 303 reduces the difference between the two, the reward value (R_t) is enlarged, and such action is encouraged; if the action executed by the reinforcement learning model 303 increases the difference between the two, the reward value (R_t) is reduced, and such action is not encouraged.

In reinforcement learning, the reinforcement learning model 303 continuously interacts with the environment 301, and learns an optimal strategy by means of the process of observing the state, choosing an action, receiving a reward value, and so on. The reinforcement learning model 303 gradually improves its strategy by means of trial and error and feedback mechanisms to maximize the accumulated rewards and complete required tasks, such as approaching the benchmark truth learning rate.

One of the main challenges in adjusting a learning rate during training of the target machine learning model is to balance a relationship between exploration and utilization. Exploration refers to trying different learning rates, which may lead to better convergence and performance, while utilization refers to adhering to learning rates that have been proven effective to date. The trade-off between exploration and utilization is necessary to avoid falling into local optimality or surpassing global optimality.

In embodiments according to the present disclosure, the disclosed method combines two different methods for predicting a learning rate: a reinforcement learning model and a machine learning model. The reinforcement learning model can explore different learning rates based on the trial and error feedback of a loss function which serves as a reward signal. The machine learning model can utilize historical data from previous training tasks and generalize well in different settings. By combining these two models, a balance can be achieved between exploration and utilization, as well as between robustness and accuracy.

The reinforcement learning model can be adapted to dynamic changes of a loss case, and find new learning rates so as to improve convergence and performance of training tasks. However, due to its randomness, the reinforcement learning model may also suffer from high variance and instability. The machine learning model can utilize prior knowledge and experience from previous training tasks and predict learning rates that may be applicable to similar tasks. However, due to its certainty, the machine learning model may also experience bias and over-fitting. Therefore, these two models are used in parallel, and the optimal model is chosen according to quality indicators, i.e., the reduction in predicted loss values. The reduction in predicted loss values can be calculated by comparing the current loss value with the predicted loss value after applying a certain learning rate. The chosen learning rate indicates the maximum reduction in the predicted loss value for the next round of training. In this way, the advantages of these two models can be utilized, and their limitations can be compensated for.

It should be understood that the method implemented according to the present disclosure is not aimed at completely eliminating hyperparameter adjustment, but instead at automating and optimizing one of its most important aspects, i.e., learning rate. The method implemented according to the present disclosure does not require fine-tuning of all hyperparameters of the two models. In fact, reasonable default values can be used in the method implemented according to the present disclosure to work well in most cases. The method implemented according to the present disclosure can also benefit from existing hyperparameter optimization methods, such as grid search, random search, evolutionary algorithm, or Bayesian optimization. Grid search is a simple and widely used technique that involves testing different combinations of hyperparameters on a validation set and choosing the optimal combination based on performance indicators. Bayesian optimization is a more complex method that involves constructing a probability model of a target function (such as validation errors) and using it to guide the search for the best hyperparameter. The hyperparameters of the two models are considered as input and the reduction in predicted losses is considered as output, and both of the two techniques can be applied to the method implemented according to the present disclosure. According to embodiments of the present disclosure, the method can be summarized as an ensemble method, where two models (the reinforcement learning model and the machine learning model) predict values of the same parameter (the learning rate), and choose the optimal predicted value based on quality metrics (the reduction in predicted losses).

Additionally or alternatively, the method implemented according to the present disclosure can be expanded more easily to prediction of other hyperparameters or parameters affecting a training process, for example, predicting, respectively by the reinforcement learning model and the machine learning model based on the multiple parameters extracted from the target machine learning model, a momentum, weight attenuation, a loss rate, and a batch size that have minimum loss values and are for the target machine learning model. For example, these variable parameters can be added to the state and the action space of the reinforcement learning model, and the reward function is correspondingly modified so as to cause the reinforcement learning model and/or the machine learning model to predict corresponding parameters having the minimum loss values.

Experimental results for illustrative embodiments will now be described. The following more particularly describes example experimental results obtained using grid search and Bayesian optimization to adjust some key hyperparameters of the method implemented according to the present disclosure, such as a discount factor and an exploration rate of the reinforcement learning model, as well as the number of hidden layers and neurons for the machine learning model. The method implemented according to the present disclosure is compared with different baselines by using different hyperparameter optimization techniques. The experimental results indicate that regardless of the hyperparameter optimization technique used, the method implemented according to the present disclosure can achieve faster convergence and better performance than existing methods.

First, experiments are conducted on a benchmark dataset used for machine learning model tasks, and the benchmark dataset includes but is not limited to MNIST (Handwritten Digit Recognition), CIFAR-10 (Image Classification), and IMDB (sentiment analysis). The method implemented in the present disclosure is compared with three baselines, such as a constant learning rate, a gradient descent-based adaptive learning rate (AdaGrad), and a momentum-based adaptive learning rate (Adam). In addition to the learning rate, the same network architecture and hyperparameters are used for each dataset and method. Each experiment is run 10 times using different random seeds, and accuracy and the average and standard deviation of loss indicators is reported.

The experimental results are shown in Table 1 below. It can be seen from the experimental results that the method implemented according to embodiments of the present disclosure is better than the baselines of all datasets in aspects of accuracy and losses. The method implemented according to embodiments of the present disclosure achieves the highest accuracy of 99.2% in MNIST, achieves 86.7% in CIFAR-10, and achieves 91.3% in IMDB. The method implemented according to embodiments of the present disclosure achieves the minimum loss of 0.03 in MNIST, achieves the minimum loss of 0.41 in CIFAR-10, and achieves the minimum loss of 0.22 in IMDB. The results indicate that the method implemented according to embodiments of the present disclosure can be effectively adapted to the learning rate in a training process, so as to improve the convergence and performance of a machine learning task.

TABLE 1

| | | Accuracy | |
|---|---|---|---|
| Dataset | Method | (%) | Loss |
| MNIST | Constant | 97.8 ± 0.1 | 0.08 ± 0.01 |
| MNIST | AdaGrad | 98.6 ± 0.1 | 0.05 ± 0.01 |
| MNIST | Adam | 98.9 ± 0.1 | 0.04 ± 0.01 |
| MNIST | The method of the | 99.2 ± 0.1 | 0.03 ± 0.01 |
| | present disclosure | | |
| CIFAR-10 | Constant | 78.4 ± 0.5 | 0.67 ± 0.02 |
| CIFAR-10 | AdaGrad | 81.2 ± 0.4 | 0.59 ± 0.02 |
| CIFAR-10 | Adam | 84.3 ± 0.3 | 0.48 ± 0.02 |
| CIFAR-10 | The method of the | 86.7 ± 0.3 | 0.41 ± 0.02 |
| | present disclosure | | |
| IMDB | Constant | 87.6 ± 0.4 | 0.29 ± 0.01 |
| IMDB | AdaGrad | 89.2 ± 0.3 | 0.26 ± 0.01 |
| IMDB | Adam | 90.4 ± 0.2 | 0.24 ± 0.01 |
| IMDB | The method of the | 91.3 ± 0.2 | 0.22 ± 0.01 |
| | present disclosure | | |

In some embodiments, the performance of the method implemented according to embodiments of the present disclosure in different hyperparameter settings can also be evaluated. The method implemented according to embodiments of the present disclosure can be compared with an existing adaptive learning rate selection method (such as AdaGrad, Adam, and a cyclical learning rate). One of the above three benchmark datasets, i.e., MNIST is used to adjust the following hyperparameters: the discount factor (γ) and the exploration rate (E) of the reinforcement learning model, and the number of hidden layers (L) and neurons (N) of the machine learning model. Grid search is used to test different combinations of these hyperparameters on the validation set, and an optimal combination is chosen according to accuracy indicators. Other hyperparameters are recovered to default values. The following Table 2 shows default hyperparameters for the method implemented according to embodiments of the present disclosure.

TABLE 2

| Hyperparameter | Value |
|---|---|
| Learning rate (α) | 0.01 |
| Batch size | 32 |
| Activation function | ReLU |
| Loss function | Cross entropy |

Table 3 shows accuracy and losses of the method implemented according to embodiments of the present disclosure, and baselines of each dataset and test set, the training time, the number of periods required for achieving the convergence, and the hyperparameter adjustment results.

TABLE 3

| Dataset | Method | Accuracy (%) | Loss | Time | Period |
|---|---|---|---|---|---|
| MNIST | Constant | 97.8 ± 0.1 | 0.08 ± 0.01 | 12.3 ± 0.5 | 10 ± 1 |
| MNIST | AdaGrad | 98.6 ± 0.1 | 0.05 ± 0.01 | 14.7 ± 0.6 | 9 ± 1 |
| MNIST | Adam | 98.9 ± 0.1 | 0.04 ± 0.01 | 15.2 ± 0.7 | 8 ± 1 |
| MNIST | CLR | 99.1 ± 0.1 | 0.03 ± 0.01 | 16.4 ± 0.8 | 7 ± 1 |
| MNIST | The method of the present | 99.3 ± 0.1 | 0.02 ± 0.01 | 11.8 ± 0.4 | 6 ± 1 |
| | disclosure | | | | |
| | (γ = 0.9, ∈ = 0.1, | | | | |
| | L = 2, N = 64) | | | | |

To evaluate effectiveness of the method implemented according to embodiments of the present disclosure, experiments were performed on multiple benchmark datasets of an image classification task by using the method implemented according to embodiments of the present disclosure. The result is compared with a result obtained by using a conventional method (such as a fixed learning rate and a stepped attenuation learning rate). The experimental results show improvements such as faster convergence. The method implemented according to embodiments of the present disclosure shows that compared with the conventional method, the number of iterations required by the convergence is reduced by 10% on average; in terms of accuracy improvement, compared with the conventional method on the benchmark dataset, the average accuracy of the method implemented according to embodiments of the present disclosure is improved by 3%; and in terms of stable performance, compared with the conventional method, the method implemented according to embodiments of the present disclosure exhibits more stable performance under various hyperparameter settings.

The above experimental results show that, compared with conventional adaptive methods for learning rate in machine learning, the method implemented according to embodiments of the present disclosure provides improved and more stable performance. The method of embodiments of the present disclosure combines the advantages of reinforcement learning and machine learning models, and provides a more intelligent and more efficient method to adjust the learning rate. The method of embodiments of the present disclosure also introduces a reward function to balance improvement of the loss function and guides the updating of learning rate. A strategy network is also designed in the method of embodiments of the present disclosure, and is used to predict a future value of the learning rate according to the current loss and weight. In addition, machine learning can be used in the method of embodiments of the present disclosure for directly updating parameters so as to improve the speed.

In conclusion, the method implemented according to embodiments of the present disclosure adjusts, by combining the reinforcement learning and machine learning models, the learning rate during the machine learning training, which is a significant improvement for conventional methods. The method implemented according to embodiments of the present disclosure predicts a future value of the learning rate and adjusts the learning rate during a training process, so as to implement better convergence and better model performance. The experimental results prove the effectiveness of the disclosed solution, which provides a more intelligent and more efficient method to adapt to the learning rate in machine learning.

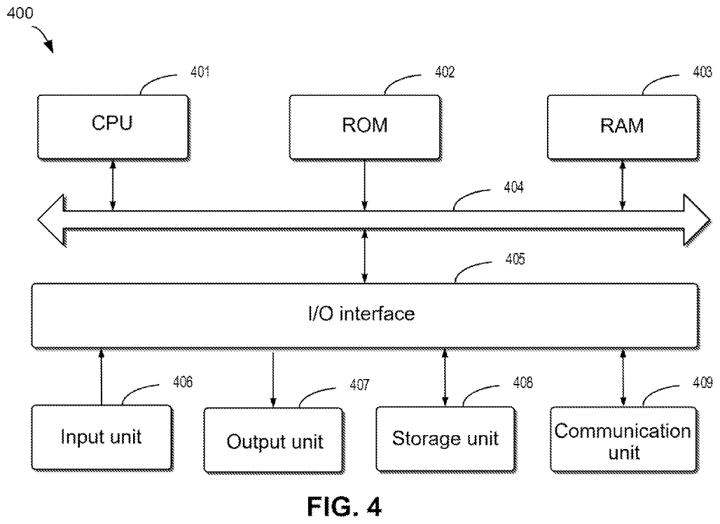

FIG. 4 shows a block diagram of an example device 400 that may be configured to implement an embodiment of the present disclosure. A computing device in the system 100 of FIG. 1 may be implemented using the device 400. As shown in the figure, the device 400 includes a central processing unit (CPU) 401 that may execute various appropriate actions and processing according to computer program instructions stored in a read-only memory (ROM) 402 or a computer program instructions loaded from storage unit 408 to a random access memory (RAM) 403. In the RAM 403, various programs and data required for operating by the device 400 may also be stored. The CPU 401, the ROM 402, and the RAM 403 are connected to each other through a bus 404. An input/output (I/O) interface 405 is also connected to the bus 404.

A plurality of components in the device 400 are connected to the I/O interface 405, including: an input unit 406, such as a keyboard and a mouse; an output unit 407, such as various types of displays and speakers; a storage unit 408, such as a magnetic disk and an optical disc; and a communication unit 409, such as a network card, a modem, or a wireless communication transceiver. The communication unit 409 allows the device 400 to exchange information/data with other devices via a computer network, such as the Internet, and/or various telecommunication networks.

The various processes and processing described above, for example, the method 200, may be executed by CPU 401. For example, in some embodiments, the method 200 may be implemented as a computer software program that is tangibly included in a machine-readable medium such as the storage unit 408. In some embodiments, part of or all the computer program may be loaded and/or installed onto the device 400 via the ROM 402 and/or the communication unit 409. When the computer program is loaded to the RAM 403 and executed by the CPU 401, one or more actions of the method 200 described above may be implemented.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for generating a machine learning model, wherein the method comprises:
extracting multiple parameters from a target machine learning model, wherein the multiple parameters comprise a learning rate, state information, a loss value, a gradient, and a weight, and the target machine learning model is configured to execute tasks related to at least one of images, videos, voice, and text;
predicting, by a first machine learning model based on the multiple parameters, a first learning rate associated with the target machine learning model;
predicting, by a second machine learning model based on the multiple parameters, a second learning rate associated with the target machine learning model;
choosing, based on the first learning rate and the second learning rate, a learning rate having a minimum loss value in the first learning rate and the second learning rate; and
adjusting the target machine learning model based on the learning rate having the minimum loss value.

2. The method according to claim 1, wherein choosing, based on the first learning rate and the second learning rate, the learning rate having the minimum loss value in the first learning rate and the second learning rate comprises:
comparing the first learning rate and the second learning rate respectively with a target benchmark learning rate to choose a learning rate having a minimum difference from the target benchmark learning rate; and
wherein the target benchmark learning rate has been determined by using a grid search method.

3. The method according to claim 1, further comprising:
predicting, by the first machine learning model, the first learning rate associated with the target machine learning model based on the state information and the loss value of the target machine learning model in the multiple parameters.

4. The method according to claim 1, further comprising:
predicting, by the second machine learning model, the second learning rate associated with the first machine learning model based on the weight and the loss value of the target machine learning model in the multiple parameters.

5. The method according to claim 1, further comprising:
adjusting the second machine learning model based on that the first learning rate is determined as the learning rate having the minimum loss value, wherein the adjustment comprises:
reducing a difference between the second learning rate generated by the second machine learning model and a target benchmark learning rate by adjusting sample data of the second machine learning model for predicting the second learning rate and a quantity of the sample data.

6. The method according to claim 1, further comprising:
adjusting the first machine learning model based on that the second learning rate is determined as the learning rate having the minimum loss value, wherein the adjustment comprises:
reducing a difference between the first learning rate generated by the first machine learning model and a target benchmark learning rate by adjusting the first machine learning model by means of one or more methods of a Q learning method and/or a strategy gradient method.

7. The method according to claim 6, further comprising:
in response to reduction of the difference between the first learning rate generated by the first machine learning model and the target benchmark learning rate, obtaining a reward value associated with the first learning rate; and
adjusting the first machine learning model based on the reward value.

8. The method according to claim 1, further comprising:
adjusting one of the first machine learning model or the second machine learning model in each iteration of multiple iteration adjustments of the target machine learning model.

9. The method according to claim 1, further comprising:
predicting, respectively by the first machine learning model and the second machine learning model based on the multiple parameters extracted from the target machine learning model, a momentum, weight attenuation, a loss rate, and a batch size that have minimum loss values and are for the target machine learning model.

10. An electronic device, comprising:
at least one processor; and
a memory, the memory being coupled to the at least one processor and storing instructions, wherein the instructions, when executed by the at least one processor, cause the electronic device to perform actions comprising:
extracting multiple parameters from a target machine learning model, wherein the multiple parameters comprise a learning rate, state information, a loss value, a gradient, and a weight, and the target machine learning model is configured to execute tasks related to at least one of images, videos, voice, and text;
predicting, by a first machine learning model based on the multiple parameters, a first learning rate associated with the target machine learning model;
predicting, by a second machine learning model based on the multiple parameters, a second learning rate associated with the target machine learning model;
choosing, based on the first learning rate and the second learning rate, a learning rate having a minimum loss value in the first learning rate and the second learning rate; and
adjusting the target machine learning model based on the learning rate having the minimum loss value.

11. The electronic device according to claim 10, wherein choosing, based on the first learning rate and the second learning rate, the learning rate having the minimum loss value in the first learning rate and the second learning rate comprises:
comparing the first learning rate and the second learning rate respectively with a target benchmark learning rate to choose a learning rate having a minimum difference from the target benchmark learning rate; and
wherein the target benchmark learning rate has been determined by using a grid search method.

12. The electronic device according to claim 10, further comprising:
predicting, by the first machine learning model, the first learning rate associated with the target machine learning model based on the state information and the loss value of the target machine learning model in the multiple parameters.

13. The electronic device according to claim 10, further comprising:
predicting, by the second machine learning model, the second learning rate associated with the first machine learning model based on the weight and the loss value of the target machine learning model in the multiple parameters.

14. The electronic device according to claim 10, further comprising:
adjusting the second machine learning model based on that the first learning rate is determined as the learning rate having the minimum loss value, wherein the adjustment comprises:
reducing a difference between the second learning rate generated by the second machine learning model and a target benchmark learning rate by adjusting sample data of the second machine learning model for predicting the second learning rate and a quantity of the sample data.

15. The electronic device according to claim 10, further comprising:
adjusting the first machine learning model based on that the second learning rate is determined as the learning rate having the minimum loss value, wherein the adjustment comprises:
reducing a difference between the first learning rate generated by the first machine learning model and a target benchmark learning rate by adjusting the first machine learning model by means of one or more methods of a Q learning method and/or a strategy gradient method.

16. The electronic device according to claim 15, further comprising:
in response to reduction of the difference between the first learning rate generated by the first machine learning model and the target benchmark learning rate, obtaining a reward value associated with the first learning rate; and
adjusting the first machine learning model based on the reward value.

17. The electronic device according to claim 10, further comprising:
adjusting one of the first machine learning model or the second machine learning model in each iteration of multiple iteration adjustments of the target machine learning model.

18. The electronic device according to claim 10, further comprising:
predicting, respectively by the first machine learning model and the second machine learning model based on the multiple parameters extracted from the target machine learning model, a momentum, weight attenuation, a loss rate, and a batch size that have minimum loss values and are for the target machine learning model.

19. A computer program product, the computer program product being tangibly stored on a non-transitory computer-readable storage medium and comprising machine-executable instructions, wherein the machine-executable instructions, when executed by a machine, cause the machine to perform the following:
extracting multiple parameters from a target machine learning model, wherein the multiple parameters comprise a learning rate, state information, a loss value, a gradient, and a weight, and the target machine learning model is configured to execute tasks related to at least one of images, videos, voice, and text;
predicting, by a first machine learning model based on the multiple parameters, a first learning rate associated with the target machine learning model;
predicting, by a second machine learning model based on the multiple parameters, a second learning rate associated with the target machine learning model;
choosing, based on the first learning rate and the second learning rate, a learning rate having a minimum loss value in the first learning rate and the second learning rate; and
adjusting the target machine learning model based on the learning rate having the minimum loss value.

20. The computer program product according to claim 19, wherein choosing, based on the first learning rate and the second learning rate, the learning rate having the minimum loss value in the first learning rate and the second learning rate comprises:
comparing the first learning rate and the second learning rate respectively with a target benchmark learning rate to choose a learning rate having a minimum difference from the target benchmark learning rate; and
wherein the target benchmark learning rate has been determined by using a grid search method.
